(19) United States
(12) Patent Application Publication
(10) Pub. No.: US 2026/0357056 A1
(43) Pub. Date: Nov. 12, 2026

(54) Block Copolymer / Thermoplastic Epoxy Resin Compositions

(71) Applicant: Arkema France, Puteaux (FR)

(72) Inventors: Anne-Laure BROCAS, Lacq (FR); Céline LABARTHE, Lacq (FR); Cathy REY, Lacq (FR)

(73) Assignee: Arkema France, Puteaux (FR)

(21) Appl. No.: 19/139,839

(22) PCT Filed: Dec. 13, 2023
(86) PCT No.: PCT/FR2023/052002

§ 371 Date: Jun. 16, 2025

(30) Foreign Application Priority Data
Dec. 16, 2022 (FR) 2213528

(51) Int. Cl. C08L 63/00; C08G 59/40; C08G 59/68; C08J 3/12; C08J 3/20; C08J 3/22; C08J 5/24

(52) U.S. Cl. CPC C08L 63/00; C08G 59/4021; C08G 59/686; C08J 3/12; C08J 3/203; C08J 3/22; C08J 5/24; C08J 2363/02; C08J 2453/00; C08L 2205/025; C08L 2205/03; C08L 2205/05; C08L 2310/00

(57) ABSTRACT

The invention relates to compositions of block copolymers and thermoplastic epoxy resins, to the use thereof in the mechanical reinforcement of filler-containing or non-filler-containing thermoset epoxy formulations, and to the filler-containing or non-filler-containing thermoset epoxy formulations obtained. The invention also relates to a process for preparing these compositions of block copolymers and thermoplastic epoxy resins.

The invention relates to compositions of block copolymers and thermoplastic epoxy resins, to the use thereof in the mechanical reinforcement of filler-containing or non-filler-containing thermoset epoxy formulations, and to the filler-containing or non-filler-containing thermoset epoxy formulations obtained. The invention also relates to a process for preparing these compositions of block copolymers and thermoplastic epoxy resins.

Epoxy resins are used in a wide variety of sectors, ranging from the manufacture of articles intended for articles in the automotive, aeronautical or sports sectors. They find applications in structural adhesives, as a matrix for composite materials or in applications for protecting electronic components. The epoxy articles or materials are obtained by reacting the functional epoxy resins with a functional curing agent. When more than 2 functionalities on the epoxy resins and/or on the curing agent are used, a thermoset material is obtained, i.e. a material having a certain crosslinking density. Through the crosslinking density it is possible to adjust the properties and also the nature of the epoxy resins and the nature of the curing agent(s). Thermally cured epoxy materials generally have a high crosslinking density; this is to ensure a high glass transition temperature (Tg) so that the final material has good thermomechanical properties.

However, the sudden stresses experienced by mechanical parts under high loads, for example in the aeronautics sectors, have necessitated the development of improvements in certain properties such as impact resistance and limitation of crack propagation, for example.

Solutions have been provided by combining these formulations with core-shell particles or with block copolymers containing flexible blocks having a low Tg (glass transition temperature). In the case of block copolymers, this is described in EP 1290088. In FR2880895, a further improvement is provided through the presence of functional monomer in the block copolymers.

This type of block copolymer and in particular those in which at least one of the blocks has a polar and/or hydrophilic functionality are the best candidates known to date for improving the mechanical properties of epoxy resins.

There remains a technical problem when seeking the correct formulation of the block copolymer with the epoxy resin(s). The mechanical properties of the final material are optimal when the block copolymers are in what is known as a “nanostructured” state, which can only be obtained with thermodynamic steps that are not always controllable. The block copolymers useful in reinforcing epoxy resins are in pellet form at ambient temperature. The epoxy resins are in liquid or solid form at ambient temperature and mixing with the block copolymers requires stirring, time, and temperature conditions that are restrictive for the formulator. One solution that has been employed consists of grinding the pellets of block copolymer to facilitate their dilution, but this adds a step. The use of a liquid epoxy resin with a solid epoxy resin facilitates the dissolution of block copolymers in powder or pellet form, but it is necessary to heat and to stir vigorously for a lengthy period. This leads to the presence of foaming and air bubbles that cannot be completely eliminated even by performing an additional degassing and that weaken the final material.

Another solution that has been employed involves prediluting the block copolymer in a liquid epoxy resin in the form of a masterbatch that is subsequently diluted in the epoxy resin(s) of the final formulation. This solution does not eliminate the need for a step of mixing the block copolymer into a liquid epoxy resin in contents of up to 25%, which makes this academic approach unusable in industry, since the aforementioned drawbacks (foaming, bubbling, time) are exacerbated by the high proportions of block copolymers in these mixtures of block copolymers in solid form in liquid epoxies (up to 25%). Such an approach is described for example in the thesis of Andreas Peter Klingler, on page 40, under ISBN registration No. 978-3-944440-44-6.

To avoid the disadvantages associated with dissolving the block copolymer in epoxy resins, the applicant has developed a composition that facilitates the dispersion of block copolymers in epoxy resins when present in the form of pellets having a high content of block copolymer in a solid thermoplastic epoxy resin. These pellets are obtained in a kneader- or extruder-type mixing device. These pellets are mixed in much more easily, while avoiding the problems associated with the mixing time, bubbling or foaming that arise during formulation.

In addition, the compositions obtained permit a balance of final properties at equal block copolymer content greater than those obtained in the prior art.

### SUMMARY OF THE INVENTION

The invention relates to a composition by weight consisting of the following mixture M:
at least one thermoplastic epoxy resin (1) having a glass transition temperature or temperatures, as measured by DSC, above 25 °C,
at least one block copolymer (2) in proportions by weight of between 25% and 70% of the total of (1)+(2), wherein at least one block copolymer has at least one block A having a glass transition temperature Tg above 25 °C, as measured by DMA, and at least one block B having a glass transition temperature Tg below 0 °C, as measured by DMA, and having at least one polar and/or hydrophilic functional monomer in at least one of the blocks, said polar and/or hydrophilic functional monomer being present in proportions by weight relative to the block concerned of between 5% and 50%, said composition being in solid form at temperatures below 50 °C.

### DETAILED DESCRIPTION

The thermoplastic epoxy resin(s) present in the compositions of the invention has/have a Tg above 25 °C, preferably above 30 °C, and more preferably above 50 °C, as measured by DSC (differential scanning calorimetry).

These are compounds of the pure epoxy, epoxy polyester, novolac or epoxy acrylate type. They include the diglycidyl ether of bisphenol A and bisphenol F type, aromatic glycidyl amines, and cycloaliphatic epoxies, these compounds having an oxirane functionality greater than or equal to two. They may contain fluorine, phosphorus or silicon. They may be of renewable origin, based on natural oils (soybean oil, linseed oil, castor oil, etc.), based on isosorbide, on epoxidized natural rubber, on epoxy lignin derivatives, or on rosin.

The block copolymers useful in the context of the present invention are multiblock copolymers, preferably not containing butadiene. They consist of blocks A (termed hard blocks) having a glass transition temperature Tg above 25 °C, preferably above 50 °C, and more preferably above 70 °C, and blocks B (termed soft blocks) having a Tg below 0 °C, preferably below −25 °C, and are linear or star-shaped of formula (A) nB or (B) nA, and preferably (A) nB, where n takes values from 2 to 8, preferably 2 to 6, preferably 2 to 4, and more preferably 2-3, that is to say diblock or triblock, preferably triblock, linear or star-shaped copolymers. A combination of these copolymers constitutes one variant of the invention. At least one of the blocks A or B comprises at least one polar and/or hydrophilic monomer in proportions by weight of polar and/or hydrophilic monomers of between 5% and 50% of the block concerned. The term “glass transition temperature” or “Tg” refers to the temperature at which the polymer material passes from the vitreous state to a non-vitreous state, corresponding to a certain mobility of the polymer chains between one another. The glass transition temperature of the block copolymers is determined by dynamic mechanical analysis (DMA).

The expression “block copolymer” refers to a copolymer having a plurality of different polymer segments, where each segment, also referred to as a “block”, consists of a sequence of monomers, which may be identical or different. Each segment or block thus may be a homopolymer or a copolymer.

Preferably, the blocks A comprise a sequence of monomers selected from linear or branched, cyclic or non-cyclic C₁ to C₁₈ alkyl (meth)acrylates, and in particular methyl methacrylate, possibly obtained from a process of recycling by depolymerization, styrene or substituted styrenes, isobornyl (meth)acrylates, or acrylates or methacrylates substituted by polar and/or hydrophilic functions, and combinations thereof. Polar and/or hydrophilic are understood as meaning groups such as carboxylic (—COOH), hydroxyl (—OH) or amide (—CONH) type groups, or else ethylene glycol or polyethylene glycol optionally substituted at their terminal function by alkyl, phosphate, phosphonate or sulfonate groups. These include in particular (meth)acrylic acids and also alkyl acrylamides, in particular dimethylacrylamide, diethylacrylamide or isopropylacrylamide.

Preferably, blocks B will consist preferably of sequences of monomers selected from butyl acrylate, 2-ethylhexyl acrylate, octyl acrylate, nonyl acrylate, lauryl acrylate, and mixtures thereof, optionally in mixtures with styrene, acrylates or methacrylates substituted by polar and/or hydrophilic functions.

Such compounds include in particular (meth)acrylic acids and also alkyl acrylamides, in particular dimethylacrylamide, diethylacrylamide or isopropylacrylamide.

More preferably, blocks B consist of sequences of butyl acrylate monomers with or without polar and/or hydrophilic functional monomers.

Preferably, at least one of blocks A or B comprises at least one polar and/or hydrophilic functional monomer in proportions by weight of polar and/or hydrophilic functional monomers of between 5% and 50% by weight, preferably between 5% and 30%, preferably between 5% and 20% when at least one polar and/or hydrophilic functional monomer is present in the soft block B, more preferably between 5% and 12%, and when at least one polar and/or hydrophilic functional monomer is present in the hard block A preferably between 5% and 12%.

More preferably, and when at least one polar and/or hydrophilic functional monomer is present, the polar and/or hydrophilic functional monomer is present in the hard block A.

Triblock, diblock and star triblock copolymers employable without limitation in the context of the invention thus include the following, alone or as a mixture:
p(MMAcoMAA)-pBuA-p(MMAcoMAA), p(MMAcoAA)-pBuA-p(MMAcoAA), pMMA-p(BuAcoAA)-pMMA, p(MMAcoDMA)-pBuA-p(MMAcoDMA), p(MMAcoIPA)-pBuA-p(MMAcoIPA) and preferably p(MMAcoDMA)-pBuA-p(MMAcoDMA), p(MMAcoIPA)-pBuA-p(MMAcoIPA), p(MMAcoDEA)-pBuA-p(MMAcoDEA),
p(MMAcoMAA)-pBuA, p(MMAcoAA)-pBuA, p(MMAcoMAA)-p(BuAcoSty), pMMA-p(BuAcoAA), p(MMAcoDMA)-pBuA-, p(MMAcoIPA)-pBuA, p(MMAcoDEA)-pBuA and preferably p(MMAcoDMA)-pBuA, p(MMAcoIPA)-pBuA, and p(MMAcoDEA)-pBuA.
pBuA-(p(MMAcoMAA))₃, pBuA-(p(MMAcoAA))₃, p(BuAcoAA)-(pMMA)₃, pBuA-(p(MMAcoDMA))₃, pBuA-(p(MMAcoIPA))₃, pBuA-(p(MMAcoDEA))₃, and preferably pBuA-(p(MMAcoDMA))₃, pBuA-(p(MMAcoIPA))₃, p(BuAcoSty)-(p(MMAcoMAA))₃, and pBuA-(p(MMAcoDEA))₃.

In all of these block copolymers, MMA may be substituted wholly or partially by IBOA and/or IBOMA.

In the above MMA=methyl methacrylate, MAA=methacrylic acid, AA=acrylic acid, BuA=butyl acrylate, Sty=styrene, DMA=dimethylacrylamide, IPA=isopropylacrylamide, DEA=diethylacrylamide, IBOA=isobornyl acrylate, IBOMA=isobornyl methacrylate.

The block copolymers useful in the context of the present invention typically have a weight-average molecular weight, measured by SEC (size-exclusion chromatography) with polystyrene calibration, of between 10 000 and 200 000 g/mol, preferably of between 30 000 and 150 000 g/mol, and even more preferably between 30 000 and 100 000 g/mol, with a hard block/soft block weight ratio of between 20/80 and 80/20.

The block copolymers useful in the context of the present invention are preferably prepared by controlled free-radical polymerization, without precluding other methods of preparation. Controlled free-radical polymerizations make it possible to obtain block copolymers in sequential steps within the same process operation. For example, the block copolymers can be prepared by RAFT (radical addition fragmentation transfer) polymerization or by nitroxide-controlled polymerization, also known as NMP (nitroxide-mediated polymerization). Preferably, the block copolymers are prepared by NMP, in particular by NMP using the N-tert-butyl-1-diethylphosphono-2,2-dimethylpropyl nitroxide counter-radical. The synthesis of block copolymers using this counter-radical is described in particular in EP1526138.

The compositions of the invention consist of one or more epoxy resins having a Tg>25 °C, as measured by DSC, and at least one block copolymer in proportions by weight of block copolymer of between 25% and 70% of the total weight of epoxy resin and block copolymers and preferably between 27% and 55%.

It has in fact been shown that, at contents below 25%, the associated rheologies do not afford correctly extruded pellets, nor do they achieve any additional effect on the properties observed when using these masterbatches.

Above 70%, the advantages of diluting the resin with block copolymers are no longer significant compared with the use of block copolymers alone when the compositions of the invention are mixed with the final formulation of a ready-to-use epoxy resin composition.

The compositions of the invention have a viscosity of greater than 50 Pa·s at a shear gradient of between 0.1 and 100 s-1 in a temperature range of between 120 and 210 °C, and preferably between 140 and 190 °C.

The compositions of the invention are prepared using a mixing device of the single-screw or twin-screw extruder type, preferably twin-screw, or a kneader, at temperatures of between 120 and 210 °C. A degassing well, preferably one in accordance with the invention, may be present at a reduced pressure, completely eliminating bubbling phenomena within the pellets obtained.

Thus, the present invention also relates to a process for preparing the compositions of the invention, comprising the following steps:
Extruding a mixture of at least one epoxy resin, said resin(s) having a Tg as measured by DSC of above 25 °C, and block copolymers, where the proportion by weight of block copolymers is between 25% and 70% and preferably between 27% and 55%.
Optionally degassing with the aid of a vent.
Pelletizing the extrudate obtained into pellets.

The invention also relates to the use of the compositions of the invention in the formulation of ready-to-use epoxy resins, i.e. as constituents of the composition of articles once they have undergone polymerization. Ready-to-use epoxy resin formulations are formulations using the compositions of the invention in combination with at least one other epoxy resin, at least one crosslinking agent, also termed curing agent. The compositions of the invention will preferably be combined with at least one epoxy resin that is liquid at ambient temperature (25 °C) and at least one epoxy resin said to be solid at ambient temperature and having a Tg as measured by DSC of above 25 °C and preferably above 50 °C.

The curing agents employed include compounds capable of reacting in temperature ranges of between 15 and 200 °C. They can be acidic or basic. They may be aliphatic anhydride-type compounds and amine compounds having functionalities of greater than or equal to two.

The present invention also relates to epoxy-type thermoset compositions formulated with the compositions of the invention by combining the compositions of the invention, at least one epoxy resin (3), and at least one curing agent suitable for the polymerization thereof in the presence or absence of fillers such as woven or nonwoven fibers of carbon, glass, aramid, boron or silica and optionally in the presence of other adjuvants such as solvents, reactive diluents such as glycidyl ethers and esters, pigments and dyes, plasticizers, flame retardants, this list being non-exhaustive. “Formulated” is understood as meaning the homogenized mixture of the compositions of the invention consisting of a thermoplastic epoxy resin and a block copolymer, at least one second epoxy resin, and at least one curing agent.

The present invention also relates to the composite materials obtained using the compositions of the invention, whether in the form of prepregs or as thermally cured composite articles.

### Example 1: Preparation of the Compositions of the Invention

### Starting Materials Used:

The block copolymer, denoted BCP, has a block in which the Tg is below 0 °C and a block in which the Tg is above 25 °C. The block copolymer has acrylamide functionality. This type of copolymer is available under the trade name Nanostrength® from Arkema.

The employed epoxy resin of CAS No. 25036-25-3 has a Tg of 31 °C, as measured by DSC (differential scanning calorimetry), and is available under the trade name EPON™ Resin 1001F (Hexion).

A Labtech LTE 26-40 twin-screw pilot extruder, screw diameter 26 mm, L/D ratio 40, was used to extrude the compositions M at the different percentages by weight of BCP and epoxy resin shown in Table 1, under the following conditions:
Temperature profile: 70-100-130-160-180-180-180-180-180-180 °C.
Screw speed: 350 rpm, flow rate: 8 kg/h, cooling of the strand with water.

The different constituents are metered in by means of two gravimetric metering devices.

The first metering device is used for metering in the polymer, which is introduced in the main hopper.

The second metering device is used to meter in the epoxy flakes.

The products are introduced into the extruder in the main hopper. The compositions by weight are given in Table 1:

TABLE 1

| | BCP % | Epoxy resin % |
|---|---|---|
| M1 | 5 | 95 |
| M2 | 25 | 75 |
| M3 | 35 | 65 |
| M4 | 50 | 50 |

where M0 is 100% epoxy resin and M5 is 100% BCP.

### Example 2: Rheology of Compositions M

The resin used, EPON™ Resin 1001F, is worst case, since its Tg is 31 °C, with a low molecular weight. Any other resin having a Tg above 31 °C will display rheology behavior that will be more favorable to producing the compositions of the invention by extrusion with the possibility of obtaining pellets.

The viscosity of the formulations is determined on a model MCR301 imposed-stress rheometer from Anton Paar.

The measurement is performed by flow-stress sweep at the desired measurement temperature. The geometry used is of Couette or plane-plane type.

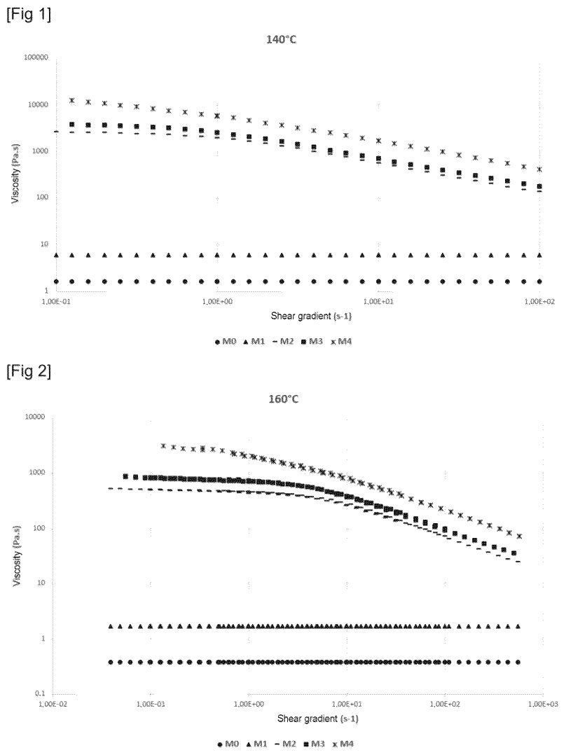

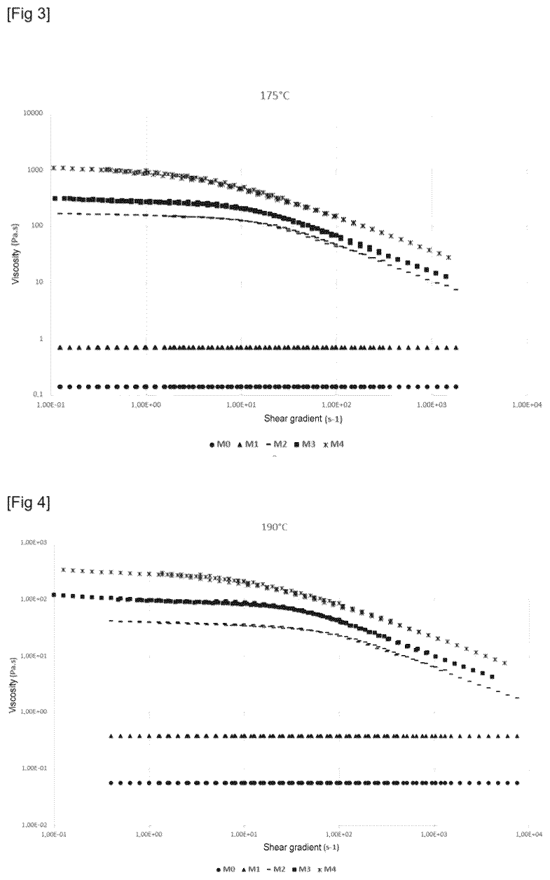

Flow plots of the viscosity as a function of shear gradient can then be obtained (FIG. 2).
FIG. 1: 140 °C,
FIG. 2: 160 °C,
FIG. 3: 175 °C,
FIG. 4: 190 °C.

The compositions of the invention have a viscosity of greater than 50 Pa·s at a shear gradient of between 0.1 and 100 s-1 in a temperature range of between 120 and 210 °C, and preferably between 140 and 190 °C.

Table 2 gives the Eta0 viscosities on the Newtonian plateau at different temperatures for compositions M0 to M5. Pelletization is possible when the compositions have an Eta0 viscosity of greater than 50 Pa·s.

TABLE 2

| | T(°C) | Eta0 (Pa · s) | Pelletization |
|---|---|---|---|
| M0 | 90 | 138 | Possible |
| | 100 | 39.9 | Possible |
| | 110 | 14.4 | Possible |
| | 130 | 2.99 | Not possible |
| | 150 | 0.9 | Not possible |
| | 160 | 0.38 | Not possible |
| | 175 | 0.14 | Not possible |
| | 190 | 0.056 | Not possible |
| M1 | 90 | 323 | Possible |
| | 100 | 111 | Possible |
| | 110 | 39.3 | Not possible |
| | 130 | 9 | Not possible |
| | 150 | 3 | Not possible |
| | 160 | 1.68 | Not possible |
| | 175 | 0.71 | Not possible |
| | 190 | 0.38 | Not possible |
| M2 | 140 | 2580 | Possible |
| | 160 | 482 | Possible |
| | 175 | 160 | Possible |
| | 190 | 40 | Not possible |
| M3 | 140 | 3796 | Possible |
| | 160 | 782 | Possible |
| | 175 | 286 | Possible |
| | 190 | 94 | Possible |
| M4 | 140 | 2.61E+04 | Possible |
| | 160 | 3837 | Possible |
| | 175 | 1655 | Possible |
| | 190 | 324 | Possible |
| M5 | 190 | 637.5 | Possible |

### Example 3: Thermally Cured Compositions and Mechanical Evaluations

This example compares the performance of thermally cured compositions in the presence of block copolymer when introducing block copolymer of the invention or block copolymer of the prior art.

Starting materials used:
Epoxy resin of bisphenol A type: available under the name Araldite® LY556 from Huntsman.
EPON™ Resin 1001F.
Epikote™ 828.
BCP copolymer available under the trade name Nanostrength®, supplier Arkema.
Dicyandiamine (DICY) CAS 461-58-3 Dyhard 100SF (supplier Alzchem)
TDI: catalyst TDI 1,1-dimethyl-3-phenylurea CAS: 101-42-8, TDI UR300 (supplier Degussa).
BYK®-P 9920: Antifoaming agent (supplier BYK).
   1) the Following Formulations were Prepared as Per Table 3:

Epoxy resin LY556 is weighed into the tank of a glass reactor equipped with a toothed flat-disk dispersion impeller at 95 °C and with stirring at 200 rpm. At 95 °C, the amount of master batch M52N+1001F is introduced through the funnel with stirring at 400 rpm for 3 or 4 h. The defoaming agent BYK P9920 is then introduced and the mixture is degassed. The mixture is then cooled to 80 °C. After having released the vacuum, the twin curing agent/accelerator is introduced with the aid of a funnel. The mixture is allowed to dissolve for 15 min and the reduced pressure is then reapplied for 35 min. The still-liquid solution (80 °C) is poured into stainless steel molds (placed in an oven at 160 °C beforehand) having a thickness of 6 mm for the K1C and G1C tests and a thickness of 2 mm for the tensile test specimens.

TABLE 3

| | EPON ™ | Araldite ® | | | | | BYK-P |
|---|---|---|---|---|---|---|---|
| % by weight | 1001F | LY556 | BCP | M4 | DICY | TDI | 9920 |
| Reference 1 | | 82.8 | 9.8 | | 5.8 | 0.2 | 1.4 |
| Reference 2 | 9.8 | 73 | 9.8 | | 5.8 | 0.2 | 1.4 |
| Invention 1 | | 73 | | 19.6 | 5.8 | 0.2 | 1.4 |

### 2) Evaluation of Mechanical Properties:

All test specimens are cut by a Charly robot (milling cutter)

TESTS: K1C G1C in accordance with standard ISO 13586:2000 Tensile standard in accordance with standard ISO 527-2:2012

Table 4 collates the values obtained demonstrating the superiority of the formulations obtained using the compositions of the invention.

TABLE 4

| | K1c max (Mpa · √m) | G1c (J/m2) | E (Gpa) |
|---|---|---|---|
| Reference 1 | 1.46 +/− 0.04 | 901 +/− 49 | 2.37 +/− 0.06 |
| Reference 2 | 2.22 +/− 0.11 | 2066 +/− 208 | 2.38 +/− 0.06 |
| Invention 1 | 2.45 +/− 0.25 | 1800 +/− 290 | 3.44 +/− 0.08 |

### Example 4: Dissolution of the formulations

The masterbatch is dissolved to a content of 10% in an Epikote 828-type resin at ambient temperature, in a beaker, with the aid of a magnetic stirrer bar. In the reference solution, 5% of block copolymers and 5% of Epon 1001F are introduced into an Epikote 828-type resin.

After 3 h, the solution containing the masterbatch (invention 2) is completely homogeneous, whereas the reference solution 3 still contains undissolved pellets and has air bubbles, Table 5:

TABLE 5

| | Epikote ™ | EPON ™ | | | Mixing | |
|---|---|---|---|---|---|---|
| | 828 | 1001F | BCP | M4 | time (h) | Bubbling |
| Reference 3 | 90 | 5 | 5 | 0 | 4 | yes |
| Invention 2 | 90 | | | 10 | 3 | no |

The compositions of the invention thus make it possible to obtain better mechanical properties in formulations with epoxy resins, and are easier to use.

1. A composition by weight consisting of the following mixture M:
at least one thermoplastic epoxy resin having a glass transition temperature or temperatures, as measured by DSC, above 25 °C,
at least one block copolymer in proportions by weight of between 25% and 70% of the total of the at least one thermoplastic epoxy resin and the at leas one block copolymer, wherein the at least one block copolymer has at least one block A having a glass transition temperature Tg above 25 °C, as measured by DMA, and at least one block B having a transition temperature Tg below 0 °C, as measured by DMA, and having at least one polar and/or hydrophilic functional monomer in at least one of the blocks, said polar and/or hydrophilic functional monomer being present in proportions by weight relative to the block concerned of between 5% and 50%, said composition being in solid form at temperatures below 50 °C.

2. A composition comprising a homogenized mixture of a composition as claimed in claim 1, at least one second epoxy resin, and at least one curing agent.

3. The composition as claimed in claim 2, further comprising at least one woven or nonwoven fiber.

4. A prepreg comprising a composition as claimed in claim 3.

5. A composite material obtained using composition as claimed in claim 3.

6. A process for preparing a composition as claimed in claim 1, comprising:
Extruding, at a temperature of between 120 and 200 °C, a mixture of at least one epoxy resin, said at least one epoxy resin having a Tg as measured by DSC of above 25 °C, and block copolymers, where the proportion by weight of block copolymers is between 25% and 70%,
Optionally degassing with the aid of a vent,
Pelletizing the extrudate obtained into pellets.
